(19) United States
(12) Patent Application Publication
(10) Pub. No.: US 2024/0224281 A1
(43) Pub. Date: Jul. 4, 2024

(54) SEGMENTED PRE-COMPENSATION MANAGEMENT TECHNIQUES

(71) Applicant: ZTE Corporation, Shenzhen (CN)

(72) Inventors: Fangyu CUI, Shenzhen (CN); Nan ZHANG, Shenzhen (CN); Jianqiang DAI, Shenzhen (CN)

(21) Appl. No.: 18/605,617

(22) Filed: Mar. 14, 2024

Related U.S. Application Data
(63) Continuation of application No. PCT/CN2021/121152, filed on Sep. 28, 2021.

(51) Int. Cl. H04W 72/20

(52) U.S. Cl. CPC H04W 72/20

(57) ABSTRACT

A wireless communication method includes determining, by a communication device, that a time slot for a random access channel overlaps with a first set of time slots allocated for a shared channel, and transmitting, in response to the determining, the shared channel in a second set of time slots, where the second set of time slots are different than the first set of time slots.

### CROSS REFERENCE TO RELATED APPLICATIONS

This patent document is a continuation of and claims benefit of priority to International Patent Application No. PCT/CN2021/121152, filed on Sep. 28, 2021. The entire content of the before-mentioned patent application is incorporated by reference as part of the disclosure of this application.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for determining a time gap between segments, managing collision between a shared channel and a random access channel, user equipment (UE) reporting, and/or segmentation configuration.

A first example wireless communication method includes determining, by a communication device, that a time slot for a random access channel overlaps with a first set of time slots allocated for a shared channel; and transmitting, in response to the determining, the shared channel in a second set of time slots, wherein the second set of time slots are different than the first set of time slots. In some embodiments, the first set of time slots are associated with some or all of a first set of one or more segments and the second set of time slots are associated with some or all of a second set of one or more segments. In some embodiments, the second set of time slots do not overlap with one or more time slots for one or more random access channels that comprise the random access channel. In some embodiments, the second set of time slots are later in time than the first set of time slots.

A second example wireless communication method includes transmitting, by a communication device and within a segment associated with a time period, a portion of a shared channel at a first subset of resources and at a third subset of resources within the segment, wherein the transmitting excludes a transmission of the shared channel at a second subset of resources within the segment in response to a set of resources for at least one random access channel overlapping with the second subset of resources.

In some embodiments, the first subset of resources and the third subset of resources do not overlap with the set of resources for the at least one random access channel. In some embodiments, the portion of the shared channel allocated with the second subset of resources is not transmitted. In some embodiments, the portion of the shared channel allocated with the second subset of resources and following portions of the shared channel are transmitted at the third subset of resources and following resources for the shared channel.

A third example wireless communication method includes transmitting, by a communication device and within a segment associated with a time period, a portion of a shared channel at a first subset of resources within the segment in response to a set of resources allocated for at least one random access channel overlapping with a second subset of resources for the shared channel within the segment, wherein the first subset of resources do not overlap with the set of resources for the at least one random access channel, and wherein the transmitting excludes a transmission of the shared channel at the second subset of resources.

In some embodiments, the set of resources for the at least one random access channel include one or more time gaps and one or more segments, the one or more time gaps are located in between adjacent segments, and the transmitting excludes a transmission of the shared channel at the one or more segments.

In some embodiments, the method further includes transmitting, within another segment, a portion of the shared channel at a first subset of resources within the another segment in response to another set of resources allocated for the at least one random access channel overlapping with a second subset of resources for the shared channel within the another segment, wherein the first subset of resources do not overlap with the another set of resources for the at least one random access channel, and wherein the transmitting excludes a transmission of the shared channel at the second subset of resources. In some embodiments, the portion of the shared channel allocated with the second subset of resources within the segment, the one or more segments, and the second subset of resources within the another segment are not transmitted. In some embodiments, the portion of the shared channel allocated with the second subset of resources within the segment, the portion of the shared channel allocated with the one or more segments, the portion of the shared channel allocated with the second subset of resources within the another segment, and following portions of the shared channel are transmitted at the second subset of resources within the another segment and following resources for the shared channel.

A fourth example wireless communication method includes transmitting, by a communication device, a shared channel in a first set of time slots in response to a second set of time slots allocated for the shared channel overlapping with a random access channel, wherein the shared channel is not transmitted in the second set of time slots, and wherein the second set of time slots are located prior to the first set of time slots in time domain.

A fifth example wireless communication method includes transmitting, by a communication device and within a time period, at least a first part of a first segment and a second segment, wherein the first segment and the second segment are adjacent to each other in time domain, wherein the first segment is associated with a first timing advance value that is different from a second timing advance value associated with the second segment, and wherein the transmitting of the at least the first part of the first segment and the second segment is based on a rule.

In some embodiments, the rule specifies that the first part of the first segment and the second segment are transmitted in response to a second part of the first segment overlapping in time domain with the second segment, the second part of the first segment is located in time before the first part of the first segment, the first part of the first segment is located in time after the second segment, and the transmitting within the time period excludes a transmission of the second part of the first segment. In some embodiments, the rule specifies that the first part of the first segment and the second segment are transmitted in response to a second part of the first segment overlapping in time domain with the second segment, the second part of the first segment is located in time after the first part of the first segment, the first part of the first segment is located in time before the second segment, and the transmitting within the time period excludes a transmission of the second part of the first segment.

In some embodiments, the first segment includes only the first part and a second part, the rule specifies that a time gap is located in between the first segment and the second segment, the second part of the first segment does not overlap with the second segment, and the transmitting includes the first part of the first segment, the second part of the first segment, and the second segment. In some embodiments, the communication device transmits any one or more of: an elevation angle of the communication device, a velocity of the communication device, or a position of the communication device.

A sixth example wireless communication method includes receiving, by a network node, a shared channel in a second set of time slots in response to a time slot for a random access channel overlapping with a first set of time slots allocated for a shared channel, wherein the second set of time slots are different than the first set of time slots.

In some embodiments, the first set of time slots are associated with some or all of a first set of one or more segments and the second set of time slots are associated with some or all of a second set of one or more segments. In some embodiments, the second set of time slots do not overlap with one or more time slots for one or more random access channels that comprise the random access channel. In some embodiments, the second set of time slots are later in time than the first set of time slots.

A seventh example wireless communication method includes receiving, by a network device and within a segment associated with a time period, a portion of a shared channel at a first subset of resources and at a third subset of resources within the segment, wherein the receiving excludes a reception of the shared channel at a second subset of resources within the segment in response to a set of resources for at least one random access channel overlapping with the second subset of resources.

In some embodiments, the first subset of resources and the third subset of resources do not overlap with the set of resources for the at least one random access channel. In some embodiments, the portion of the shared channel allocated with the second subset of resources is not received. In some embodiments, the portion of the shared channel allocated with the second subset of resources and following portions of the shared channel are received at the third subset of resources and following resources for the shared channel.

A eighth example wireless communication method includes receiving, by a network device and within a segment associated with a time period, a portion of a shared channel at a first subset of resources within the segment in response to a set of resources allocated for at least one random access channel overlapping with a second subset of resources for the shared channel within the segment, wherein the first subset of resources do not overlap with the set of resources for the at least one random access channel, and wherein the receiving excludes a reception of the shared channel at the second subset of resources.

In some embodiments, the set of resources for the at least one random access channel include one or more time gaps and one or more segments, the one or more time gaps are located in between adjacent segments, and the receiving excludes a reception of the shared channel at the one or more segments. In some embodiments, the method further includes receiving, within another segment, a portion of shared channel at a first subset of resources within the another segment in response to another set of resources allocated for the at least one random access channel overlapping with a second subset of resources for the shared channel within the another segment, wherein the first subset of resources do not overlap with the another set of resources for the at least one random access channel, and wherein the receiving excludes a reception of the shared channel at the second subset of resources.

In some embodiments, the portion of the shared channel allocated with the second subset of resources within the segment, the one or more segments, and the second subset of resources within the another segment are not received. In some embodiments, the portion of the shared channel allocated with the second subset of resources within the segment, the portion of the shared channel allocated with the one or more segments, the portion of the shared channel allocated with the second subset of resources within the another segment, and following portions of the shared channel are received at the second subset of resources within the another segment and following resources for the shared channel.

A ninth example wireless communication method includes receiving, by a network device, a shared channel in a first set of time slots in response to a second set of time slots allocated for the shared channel overlapping with a random access channel, wherein the shared channel is not received in the second set of time slots, and wherein the second set of time slots are located prior to the first set of time slots in time domain.

A tenth example wireless communication method includes receiving, by a network device and within a time period, at least a first part of a first segment and a second segment, wherein the first segment and the second segment are adjacent to each other in time domain, wherein the first segment is associated with a first timing advance value that is different from a second timing advance value associated with the second segment, and wherein the receiving of the at least the first part of the first segment and the second segment is based on a rule.

In some embodiments, the rule specifies that the first part of the first segment and the second segment are received in response to a second part of the first segment overlapping in time domain with the second segment, the second part of the first segment is located in time before the first part of the first segment, the first part of the first segment is located in time after the second segment, and the receiving within the time period excludes a reception of the second part of the first segment. In some embodiments, the rule specifies that the first part of the first segment and the second segment are received in response to a second part of the first segment overlapping in time domain with the second segment, the second part of the first segment is located in time after the first part of the first segment, the first part of the first segment is located in time before the second segment, and the receiving within the time period excludes a reception of the second part of the first segment.

In some embodiments, the first segment includes only the first part and a second part, the rule specifies that a time gap is located in between the first segment and the second segment, the second part of the first segment does not overlap with the second segment, and the receiving includes the first part of the first segment, the second part of the first segment, and the second segment. In some embodiments, the network device receives any one or more of: an elevation angle of a communication device, a velocity of the communication device, or a position of the communication device.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example structure of non-terrestrial network (NTN).

FIG. 2 shows an example segmentation within an uplink transmission time period.

FIG. 3 shows an overlap between narrowband internet of things (NB-IOT) physical uplink shared channel (NPUSCH) and NB-IOT physical random access channel (NPRACH), where NPRACH ends within one NPUSCH segment.

FIG. 4A shows an overlap between NPUSCH and NPRACH, where NPRACH exceed one NPUSCH segment.

FIG. 4B shows an overlap between NPUSCH and NPRACH, where NPRACH exceeds multiple NPUSCH segments.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows an exemplary flowchart for transmission of a shared channel.

FIG. 8 shows an exemplary flowchart for transmission of a portion of a shared channel.

FIG. 9 shows another exemplary flowchart for transmission of a portion of a shared channel.

FIG. 10 shows another exemplary flowchart for transmission of a shared channel.

FIG. 11 shows an exemplary flowchart for transmission of a segments.

FIG. 12 shows an exemplary flowchart for reception of a shared channel.

FIG. 13 shows an exemplary flowchart for reception of a portion of a shared channel.

FIG. 14 shows another exemplary flowchart for reception of a portion of a shared channel.

FIG. 15 shows another exemplary flowchart for reception of a shared channel.

FIG. 16 shows an exemplary flowchart for reception of a segments.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

In non-terrestrial network (NTN), due to high mobility and altitude of satellite or aerial vehicle, the propagation delay and Doppler can be large. In order to reduce the impact of large delay and Doppler in uplink (UL) synchronization, pre-compensation with the help of assistance information from network is assumed at a user equipment (UE) side in current 3GPP discussion. In NB-IOT and eMTC, the transmission duration of one physical uplink shared channel (PUSCH) could be long since repetitions may be applied to increase coverage. Therefore, in IoT-NTN, the initial pre-compensated timing advance (TA) and Doppler may not be accurate enough for the whole transmission duration of a PUSCH or physical random access channel (PRACH) due to fast variation of propagation delay and Doppler. In order to handle this problem, the whole transmission duration of a PUSCH or PRACH should be divided into several segments and pre-compensated TA and Doppler values can be updated for each segment, which avoids the synchronization lost.

In this disclosure, the UE behaviors in segmentation pre-compensation are investigated, including how to insert uplink (UL) time gap, how to handle collision between NPUSCH and NPRACH, UE reporting, and/or segmentation configuration.

### I.(a). NTN Structure

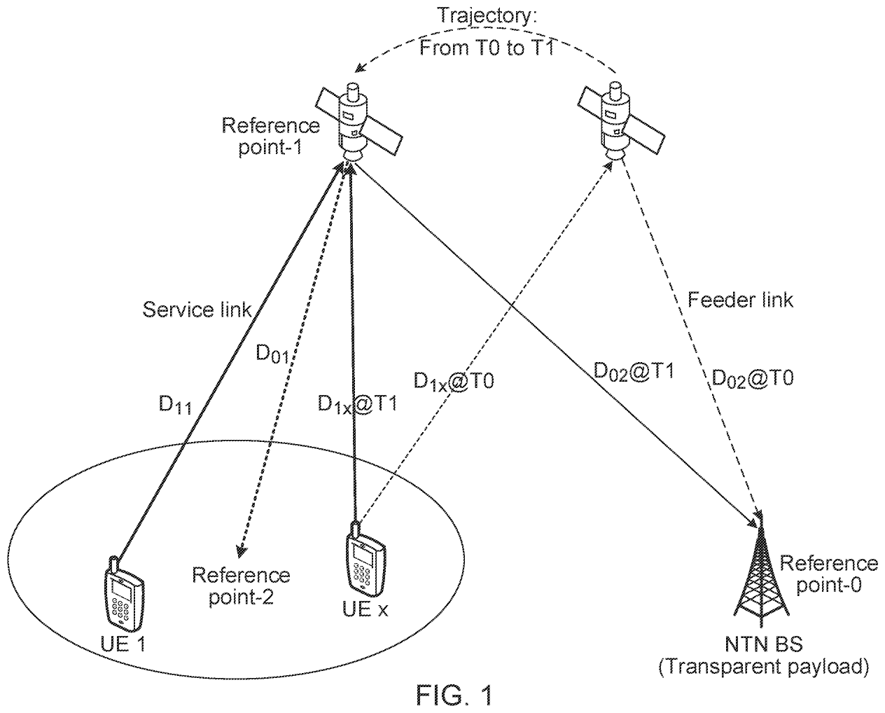

The structure of transparent NTN is illustrated in FIG. 1. The link between UE and satellite is service link while the link between BS and satellite is feeder link. Note that the feeder link delay is common for all UEs within the same cell.

### I.(b). NB-IOT

In current NB-IOT system, a 40 ms UL gap is inserted after NPUSCH transmissions and/or postponements due to NPRACH of 256 ms. The following NPUSCH transmissions are postponed after the UL gap. For NPRACH, there is similar mechanism for inserting UL gap. The difference is that the UL gap is inserted after 64 repetitions of a NPRACH for preamble format 0 and 1 and 16 repetitions for format 2.

However, 256 ms is still too long in IoT-NTN, where timing drift may exceed tolerance range. In order to keep synchronization, shorter segments should be supported for NPUSCH. Similarly, shorter segments should also be supported for NPRACH.

### I.(c). Segmented Pre-Compensation

One technique is to apply different pre-compensation of TAs and/or frequency offsets for different components of single UL transmission (i.e., segmented pre-compensation). However, the details about UL gap insertion, the method to handle collision between NPUSCH and NPRACH, and how to configure the segmentation parameters need further development.

### II. Embodiment-1: UE Report for Segmented Pre-Compensation

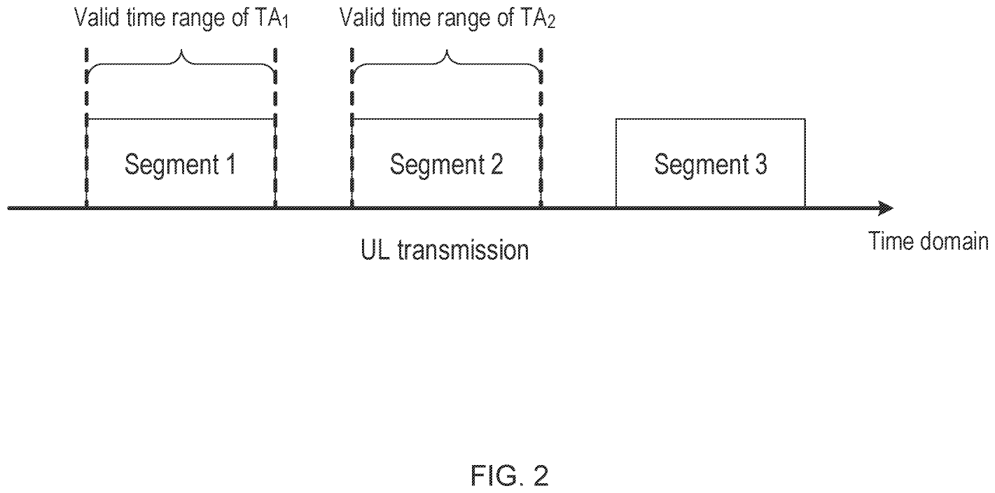

As introduced in the Introduction (Section I), the pre-compensated TA and frequency offset values should be able to be updated within one UL transmission time period in IoT-NTN to ensure the timing and/or frequency drifts are within the tolerable range. Hence, a whole transmission time period should be divided into segments and for each segment the pre-compensated TA and/or frequency offset can be updated as shown in FIG. 2. In some embodiments, the time period corresponds to a transmission duration of a message for a shared channel or a random access channel. In some embodiments, the time period comprises a plurality of segments.

In different scenarios, e.g., with different elevation angle, the drift rates of TA and Doppler are different so that the required segment length is also different. In order to achieve better performance, UE could report its information to help BS configure the segmentation parameters, e.g., segment length. For this purpose, UE could consider reporting any one or more of the UE's elevation angle, position, and velocity.

In addition, due to the possible mobility of satellite and UE, the reported information may be accurate only within a certain period. Hence, UE can also report the time information associated with reported information so that BS and UE have consensus on the validity of reported information.

In summary, the UE could report any one or more of the following to the BS:
1. Elevation angle.
2. UE velocity.
3. UE position.
4. Time information corresponding to reported information.

The report can be performed or transmitted by the UE within pre-configured UL resource, BS scheduled PUSCH, or directly along with the segmentation UL transmission.

### III. Embodiment-2: How to Handle Collision Between NPUSCH and NPRACH

In NB-IOT system, the resources for NPUSCH and NPRACH may be conflicted. During the transmission of a NPUSCH, a NPRACH occasion may be inserted. In this case, three example methods can be considered to handle the collision as mentioned below:
1. Postponement NPUSCH transmission. When the resources for NPUSCH transmission are overlapped with resources for NPRACH occasion, the corresponding NPUSCH transmission that overlaps with the NPRACH occasion should be postponed until the NPRACH transmission is finished. Note that in NPUSCH transmission, the repetition is done based on certain basic time unit, e.g., Nₛₗₒₜₛ. Therefore, in order to avoid breaking the basic unit and make the repetition combination easier, the postponement of NPUSCH should be performed based on the basic time unit for resource mapping. For example, if the basic time unit during the mapping from a block of complex-valued symbols to physical resources is Nₛₗₒₜₛ>1 slots but only one slot overlaps with the NPRACH resources, these Nₛₗₒₜₛ slots transmission of NPUSCH should all be postponed until next Nₛₗₒₜₛ slots not overlapping with any NPRACH resources. Moreover, when Nₛₗₒₜₛ>1, an additional constraint that the first slot of Nₛₗₒₜₛ slots satisfying nₛ mod Nₛₗₒₜₛ=0 can be considered to make the scheduling easier, where nₛ denotes the slot number within a radio frame. When Nₛₗₒₜₛ=2, the first slot of Nₛₗₒₜₛ slots satisfying nₛ mod Nₛₗₒₜₛ=0 means that the index of the first slot is an even number.
2. Drop the overlapped part of NPUSCH transmission. In this case, the collision resources are allocated for NPRACH transmission. The NPUSCH transmission mapped to these resources are dropped. Since the NPUSCH transmission may have multiple transmissions, the decoding may be successful even if some parts are dropped.
3. Cancel the NPUSCH transmission. Different from the second method, the whole NPUSCH transmission is stopped in this case. And, different than the first method in which only the overlapped part of the NPUSCH is postponed for a later transmitted, in this method the entire PUSCH transmission over a set of resources is cancelled. The NPUSCH transmission may be restarted later in other allocated resources.

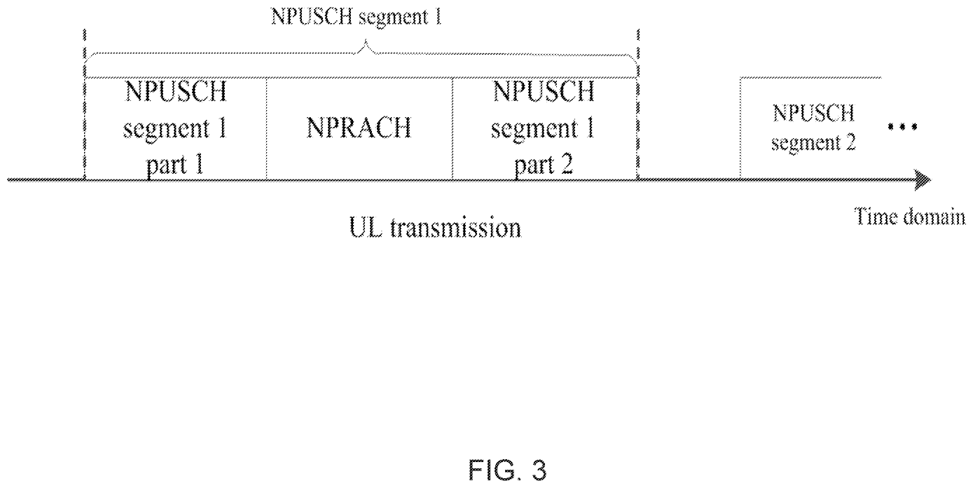

In the first and second methods mentioned above, since NPUSCH transmission will continue after finishing the NPRACH transmission, how to handle the segmentation should also be considered. In order to simplify the specification, the postponements or dropping duration of NPUSCH due to NPRACH collision should also be counted in segment duration as shown in FIG. 3. For example, assume that NPUSCH segment length is 32 ms, a 10 ms NPRACH transmission is inserted after 12 ms NPUSCH transmission. Then only 10 ms NPUSCH transmission should be performed after NPRACH transmission to fill one NPUSCH segment, i.e., the 10 ms NPRACH transmission is counted in the 32 ms NPUSCH segment duration.

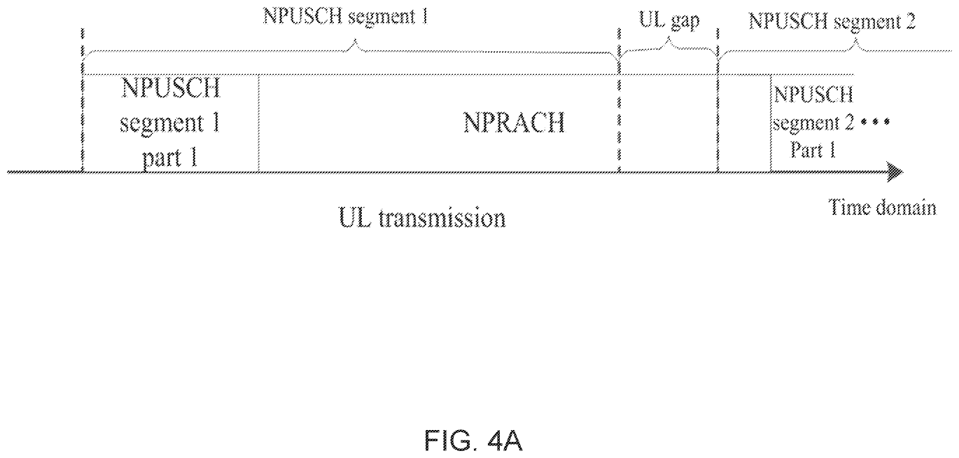

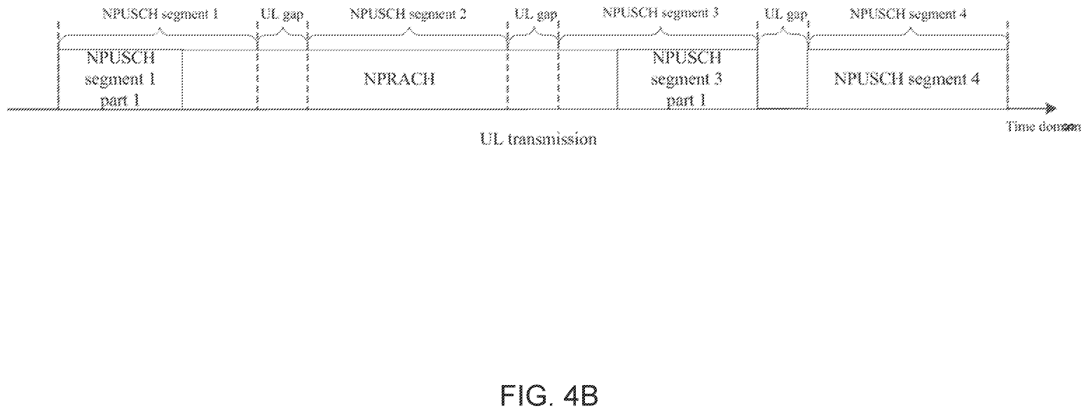

Moreover, the UE transmitting NPUSCH is in connected mode and is not likely to insert a NPRACH transmission during NPUSCH duration. Hence, during the NPRACH duration, the UE transmitting NPUSCH can be regarded as suspending the UL transmission. That is, the postponements or dropping duration of NPUSCH due to NPRACH collision can be directly utilized as UL gap, where UE may receive DL signal, calibrate oscillator, adjust compensated TA and/or frequency offset values. In order to avoid unnecessary waste of time resources, the portion of postponements or dropping duration of NPUSCH due to NPRACH which coincides with a gap (if required) is counted as part of the gap as shown in FIG. 4A. As shown in FIG. 4A, the NPRACH is transmitted by the UE through the UL gap and through at least part of the resources allocated to the NPUSCH segment 2. There is no need to specifically add a UL gap for NPUSCH during the resources occupied by NPRACH. In some embodiments, as shown in FIG. 4A, the PRACH may overlap with two segments and on an UL gap. In some other embodiments, as shown in FIG. 4B, the PRACH may be long enough to overlap a plurality of segments and a plurality of UL gaps. For example, in a scenario with three segments and two UL gaps (one UL gap in between two adjacent segment), a latter portion of a first segment, a whole portion of the second segment, and a first portion of the third segment and the two UL gaps may all be overlapped with PRACH, where the first segment, the second segment, and the third segment are in order in time domain.

### IV. Embodiment-3: How to Handle Overlap Due to TA Variation

Since different segments could apply different TA values as shown in FIG. 2, there may be overlap between two adjacent segments so that larger TA is applied in the second segment of the two adjacent segments, where the second segment is located after the first segment of the two adjacent segments in time domain. In order to avoid interference caused by overlap, following methods can be considered:
1. Drop the overlapping part of following segment.
2. Drop the overlapping part of previous segment.
3. Insert UL gap between adjacent segments to avoid overlap.

In the first two methods, i.e., dropping the overlapping part of one segment, the interference can be avoided without inserting additional gaps. However, certain performance, e.g., PAPR, will still decrease due to phase discontinuity and puncturing of signal. Hence, the third method, i.e., inserting additional UL gaps between adjacent segments, can be considered since it completely solve the overlap problem. In general case, the UL gap can be set as 1 slot. When subcarrier space is 15 kHz, 2 slots UL gap can also be considered to make scheduling easier.

When UL gap is configured, the UL gap can be inserted after the transmission of one segment and the transmission of following segments is postponed. The time resources for UL gaps are not counted in the resources for UL transmission. For example, if UE is allocated with 2*N slots for UL transmission and segment length is N, the UE will first transmit first segment using N slots, then insert a UL gap (assumed to be 1 slot here), and then transmit the second segment using N slots. That is, the total length is 2*N+1 slots but only 2*N slots for actual transmission are counted.

If the segmentation configuration is updated during the UL transmission, the newly indicated segmentation parameters, e.g., segment length and UL gap length, can be applied after finishing the transmission of current segment.

### V. Embodiment-4: Configuration of Segmentation Parameters

In different scenarios, e.g., with different elevation angle, the drift rates of TA and Doppler are different so that the required segment length is also different. For example, with low elevation angle, the TA drifts fast and requires frequent update so that the segment length should be shorter. Therefore, the segment length should be configurable. Since BS and UE should both know this value, it's better to let BS determine the segment length and indicate to UE.

### Case-1: Configuration of PUSCH Segmentation

The PUSCH transmission is performed in RRC-CONNECTED mode. In this case, UE could report its information to BS to help determine the segmentation parameters. Hence, the following three methods can be considered for segmentation configuration:
1. BS broadcast the segmentation parameters through SIB. In this method, BS determines the segmentation parameters can broadcast to all served UEs. This method is straightforward and saves the signaling overhead. The information known at BS, e.g., satellite deployment, can help to determine the parameters.
2. BS indicates segmentation parameters in UE specific way via RRC signaling, MAC CE, or DCI. In this method, UE should report its information which impact the segmentation configuration, e.g., elevation angle, velocity, etc., to BS to help determine the segmentation parameters. Moreover, the information already known at BS, e.g., satellite deployment and numerology, can also help to determine the parameters. This method can further improve the performance but is more complex and cost more signaling.
3. BS indicates segmentation parameters for a group of UEs via group common DCI. This method achieves a tradeoff between signaling cost and system performance when compared to above two methods.

The above methods have different advantages and are suitable to different scenarios:
1. When UE is not likely to report its information, e.g., in msg3 of RACH procedure or the connection time is short, the SIB broadcast method is preferred.
2. When the required segment length varies for different UEs within same cell, the UE specific signaling method is preferred. Moreover, if the segment length is required to be fast updated, DCI based signaling is preferred. Otherwise, MAC CE or RRC based signaling are more suitable.
3. When the UE density is high, group signaling method can be adopted to tradeoff the signaling overhead and performance.

### Case-2: Configuration of PRACH Segmentation

The transmission of PRACH preamble is at the initial access before moving RRC_CONNECTED mode. Therefore, UE cannot report its information to help BS to determine how to configure segmentation and BS cannot configure the segmentation parameters through RRC signaling. Hence, let BS broadcast the segmentation parameters through SIB is a proper way for configuration.

Of course, if UE will access the network several times within a short period, things are different. In this case, BS could configure the PRACH segmentation parameters through UE specific configuration or group common configuration based on reported information from UE and already known information at BS (i.e., method (2) and (3) in case-1) in current connection and UE will apply this configuration in next access. This method can be optional since it is not applicable for all scenarios.

In the segmentation configuration, the indicated segmentation parameters from BS include at least one of the followings:
1. Segment length. The unit of segment length can be set according to the repetition unit. For example, in NPUSCH, the UL transmission and repetition are performed based on slots. While for NPRACH, the UL transmission and repetition are performed based on symbol groups. By setting the segment length unit based on repetition unit, the repetition combination will be easier.
2. UL gap length.

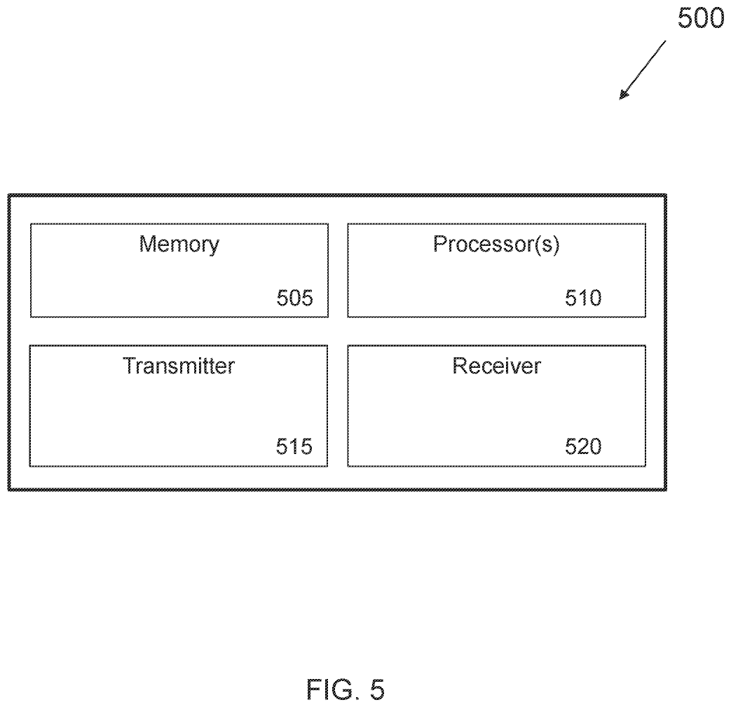

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4B and 6 to 16 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

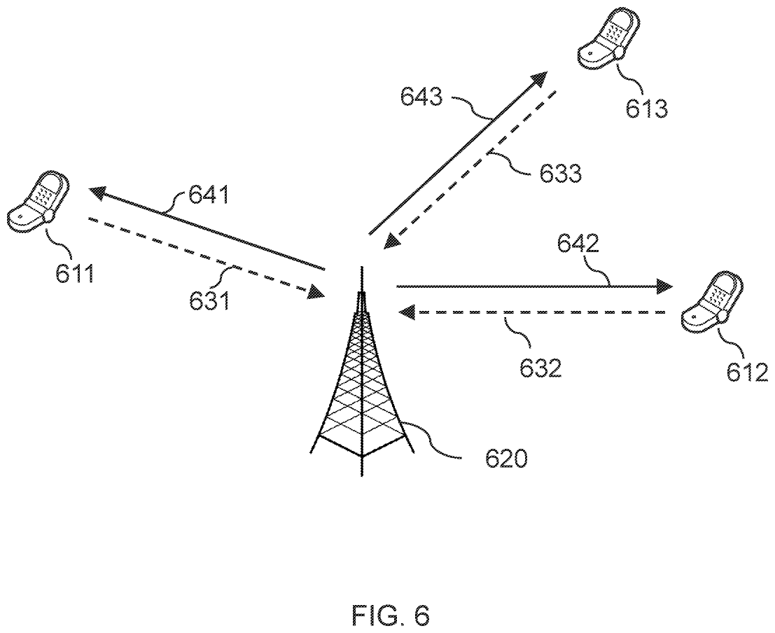

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IOT) device, and so on.

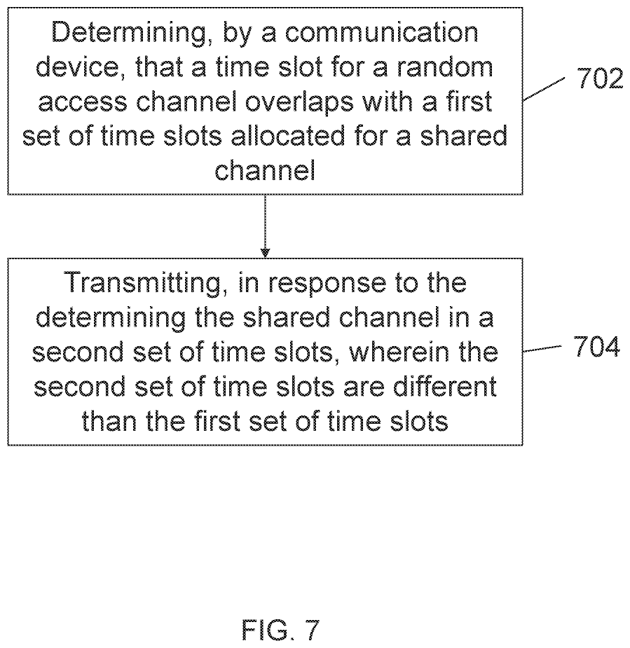

FIG. 7 shows an exemplary flowchart for transmission of a shared channel. Operation 702 includes determining, by a communication device, that a time slot for a random access channel overlaps with a first set of time slots allocated for a shared channel. Operation 704 includes transmitting, in response to the determining, the shared channel in a second set of time slots, wherein the second set of time slots are different than the first set of time slots.

In some embodiments, the first set of time slots are associated with some or all of a first set of one or more segments and the second set of time slots are associated with some or all of a second set of one or more segments. In some embodiments, the second set of time slots do not overlap with one or more time slots for one or more random access channels that comprise the random access channel. In some embodiments, the second set of time slots are later in time than the first set of time slots.

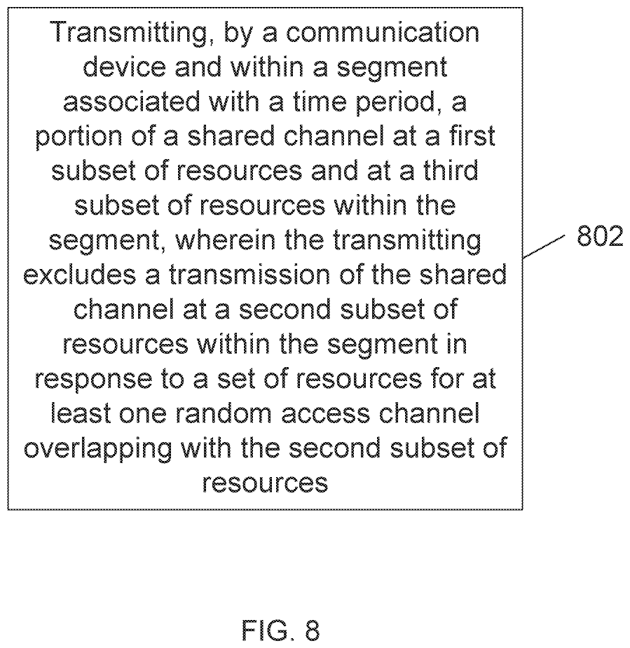

FIG. 8 shows an exemplary flowchart for transmission of a portion of a shared channel. Operation 802 includes transmitting, by a communication device and within a segment associated with a time period, a portion of a shared channel at a first subset of resources and at a third subset of resources within the segment, wherein the transmitting excludes a transmission of the shared channel at a second subset of resources within the segment in response to a set of resources for at least one random access channel overlapping with the second subset of resources.

In some embodiments, the first subset of resources and the third subset of resources do not overlap with the set of resources for the at least one random access channel. In some embodiments, the portion of the shared channel allocated with the second subset of resources is not transmitted. In some embodiments, the portion of the shared channel allocated with the second subset of resources and following portions of the shared channel are transmitted at the third subset of resources and following resources for the shared channel.

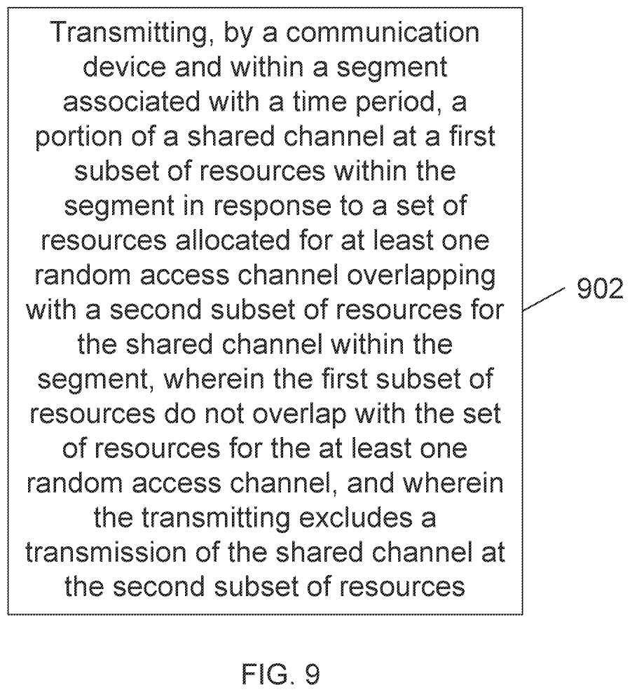

FIG. 9 shows an exemplary flowchart for transmission of a portion of a shared channel. Operation 902 includes transmitting, by a communication device and within a segment associated with a time period, a portion of a shared channel at a first subset of resources within the segment in response to a set of resources allocated for at least one random access channel overlapping with a second subset of resources for the shared channel within the segment, wherein the first subset of resources do not overlap with the set of resources for the at least one random access channel, and wherein the transmitting excludes a transmission of the shared channel at the second subset of resources.

In some embodiments, the set of resources for the at least one random access channel include one or more time gaps and one or more segments, the one or more time gaps are located in between adjacent segments, and the transmitting excludes a transmission of the shared channel at the one or more segments.

In some embodiments, the method further includes transmitting, within another segment, a portion of the shared channel at a first subset of resources within the another segment in response to another set of resources allocated for the at least one random access channel overlapping with a second subset of resources for the shared channel within the another segment, wherein the first subset of resources do not overlap with the another set of resources for the at least one random access channel, and wherein the transmitting excludes a transmission of the shared channel at the second subset of resources. In some embodiments, the portion of the shared channel allocated with the second subset of resources within the segment, the one or more segments, and the second subset of resources within the another segment are not transmitted. In some embodiments, the portion of the shared channel allocated with the second subset of resources within the segment, the portion of the shared channel allocated with the one or more segments, the portion of the shared channel allocated with the second subset of resources within the another segment, and following portions of the shared channel are transmitted at the second subset of resources within the another segment and following resources for the shared channel.

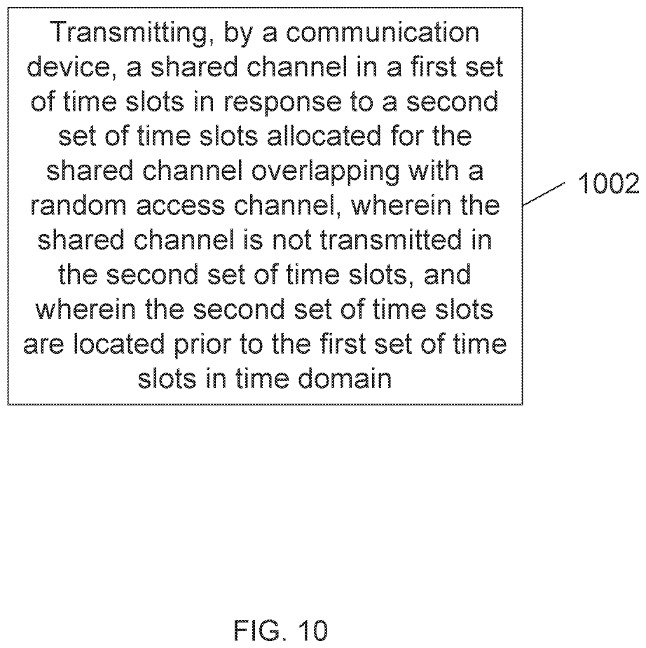

FIG. 10 shows an exemplary flowchart for transmission of a shared channel. Operation 1002 includes transmitting, by a communication device, a shared channel in a first set of time slots in response to a second set of time slots allocated for the shared channel overlapping with a random access channel, wherein the shared channel is not transmitted in the second set of time slots, and wherein the second set of time slots are located prior to the first set of time slots in time domain.

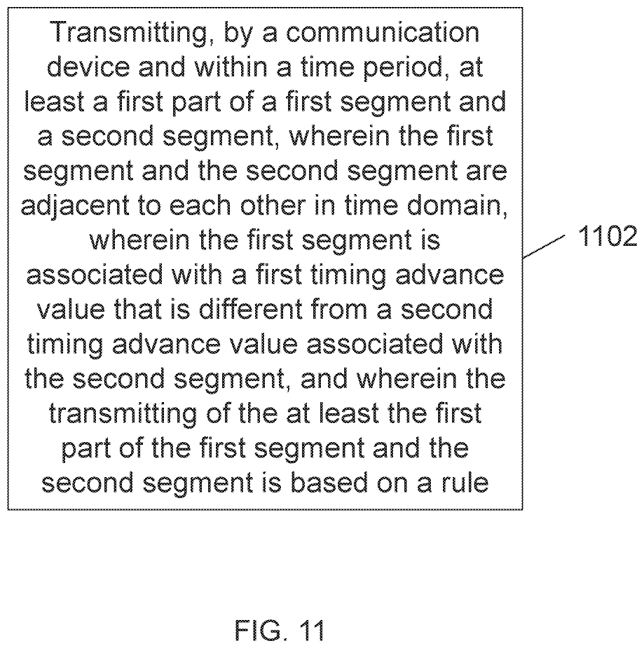

FIG. 11 shows an exemplary flowchart for transmission of a segments. Operation 1102 includes transmitting, by a communication device and within a time period, at least a first part of a first segment and a second segment, wherein the first segment and the second segment are adjacent to each other in time domain, wherein the first segment is associated with a first timing advance value that is different from a second timing advance value associated with the second segment, and wherein the transmitting of the at least the first part of the first segment and the second segment is based on a rule.

In some embodiments, the rule specifies that the first part of the first segment and the second segment are transmitted in response to a second part of the first segment overlapping in time domain with the second segment, the second part of the first segment is located in time before the first part of the first segment, the first part of the first segment is located in time after the second segment, and the transmitting within the time period excludes a transmission of the second part of the first segment. In some embodiments, the rule specifies that the first part of the first segment and the second segment are transmitted in response to a second part of the first segment overlapping in time domain with the second segment, the second part of the first segment is located in time after the first part of the first segment, the first part of the first segment is located in time before the second segment, and the transmitting within the time period excludes a transmission of the second part of the first segment.

In some embodiments, the first segment includes only the first part and a second part, the rule specifies that a time gap is located in between the first segment and the second segment, the second part of the first segment does not overlap with the second segment, and the transmitting includes the first part of the first segment, the second part of the first segment, and the second segment. In some embodiments, the communication device transmits any one or more of: an elevation angle of the communication device, a velocity of the communication device, or a position of the communication device.

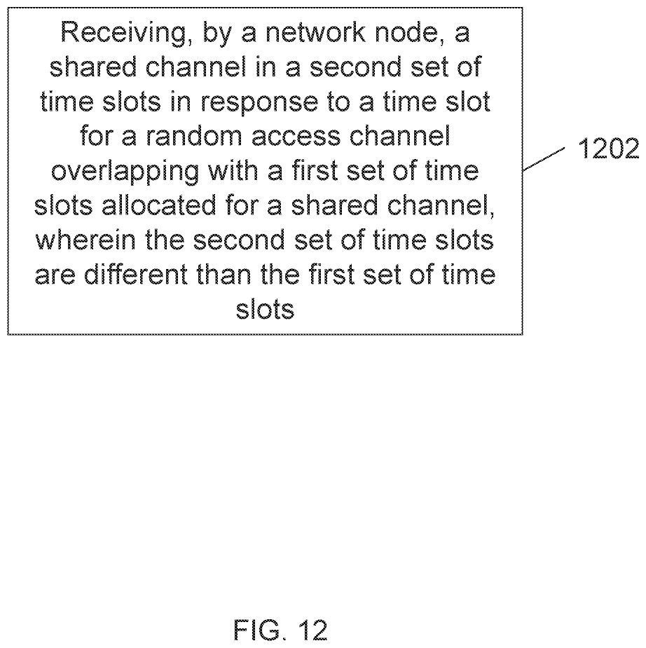

FIG. 12 shows an exemplary flowchart for reception of a shared channel. Operation 1202 includes receiving, by a network node, a shared channel in a second set of time slots in response to a time slot for a random access channel overlapping with a first set of time slots allocated for a shared channel, wherein the second set of time slots are different than the first set of time slots.

In some embodiments, the first set of time slots are associated with some or all of a first set of one or more segments and the second set of time slots are associated with some or all of a second set of one or more segments. In some embodiments, the second set of time slots do not overlap with one or more time slots for one or more random access channels that comprise the random access channel. In some embodiments, the second set of time slots are later in time than the first set of time slots.

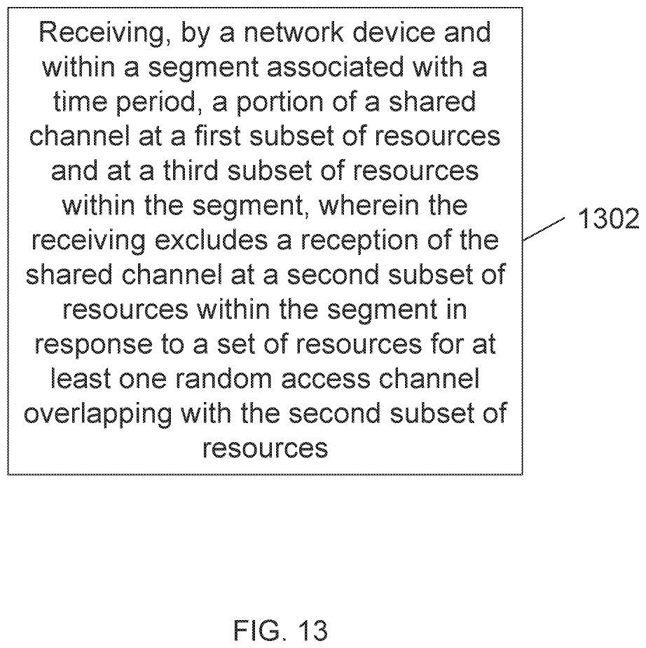

FIG. 13 shows an exemplary flowchart for reception of a portion of a shared channel. Operation 1302 includes receiving, by a network device and within a segment associated with a time period, a portion of a shared channel at a first subset of resources and at a third subset of resources within the segment, wherein the receiving excludes a reception of the shared channel at a second subset of resources within the segment in response to a set of resources for at least one random access channel overlapping with the second subset of resources.

In some embodiments, the first subset of resources and the third subset of resources do not overlap with the set of resources for the at least one random access channel. In some embodiments, the portion of the shared channel allocated with the second subset of resources is not received. In some embodiments, the portion of the shared channel allocated with the second subset of resources and following portions of the shared channel are received at the third subset of resources and following resources for the shared channel.

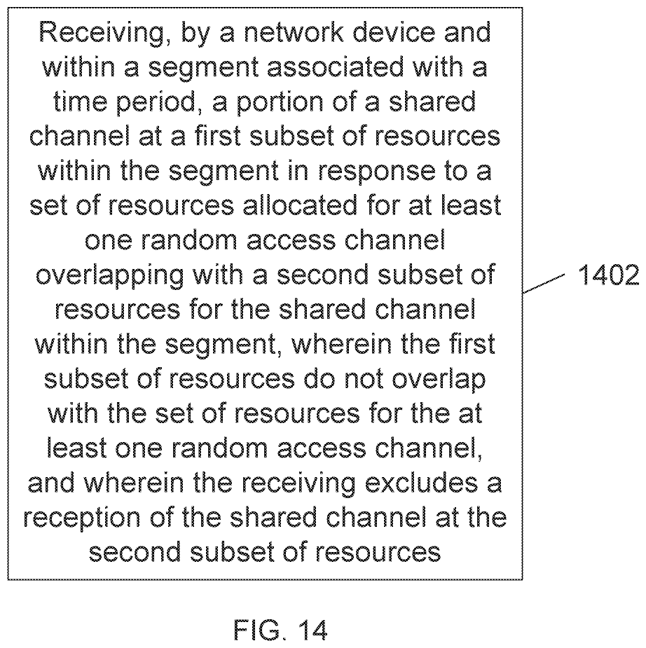

FIG. 14 shows an exemplary flowchart for reception of a portion of a shared channel. Operation 1402 includes receiving, by a network device and within a segment associated with a time period, a portion of a shared channel at a first subset of resources within the segment in response to a set of resources allocated for at least one random access channel overlapping with a second subset of resources for the shared channel within the segment, wherein the first subset of resources do not overlap with the set of resources for the at least one random access channel, and wherein the receiving excludes a reception of the shared channel at the second subset of resources.

In some embodiments, the set of resources for the at least one random access channel include one or more time gaps and one or more segments, the one or more time gaps are located in between adjacent segments, and the receiving excludes a reception of the shared channel at the one or more segments. In some embodiments, the method further includes receiving, within another segment, a portion of shared channel at a first subset of resources within the another segment in response to another set of resources allocated for the at least one random access channel overlapping with a second subset of resources for the shared channel within the another segment, wherein the first subset of resources do not overlap with the another set of resources for the at least one random access channel, and wherein the receiving excludes a reception of the shared channel at the second subset of resources.

In some embodiments, the portion of the shared channel allocated with the second subset of resources within the segment, the one or more segments, and the second subset of resources within the another segment are not received. In some embodiments, the portion of the shared channel allocated with the second subset of resources within the segment, the portion of the shared channel allocated with the one or more segments, the portion of the shared channel allocated with the second subset of resources within the another segment, and following portions of the shared channel are received at the second subset of resources within the another segment and following resources for the shared channel.

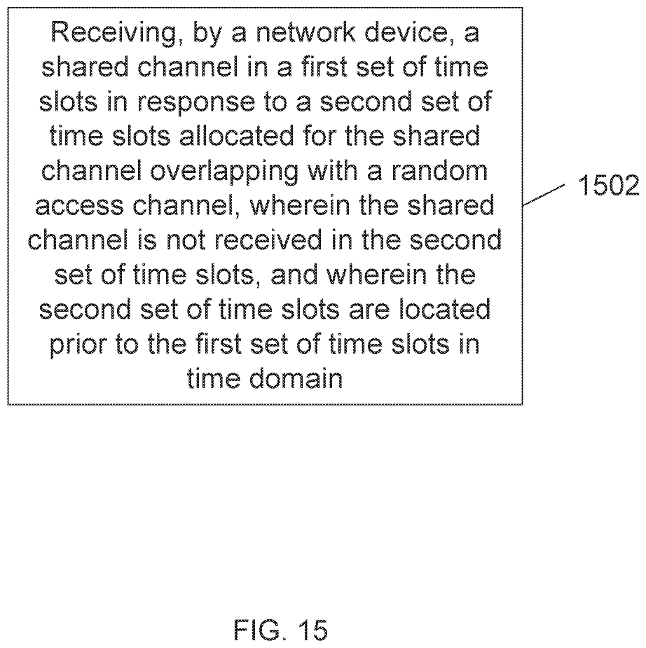

FIG. 15 shows an exemplary flowchart for reception of a shared channel. Operation 1502 includes receiving, by a network device, a shared channel in a first set of time slots in response to a second set of time slots allocated for the shared channel overlapping with a random access channel, wherein the shared channel is not received in the second set of time slots, and wherein the second set of time slots are located prior to the first set of time slots in time domain.

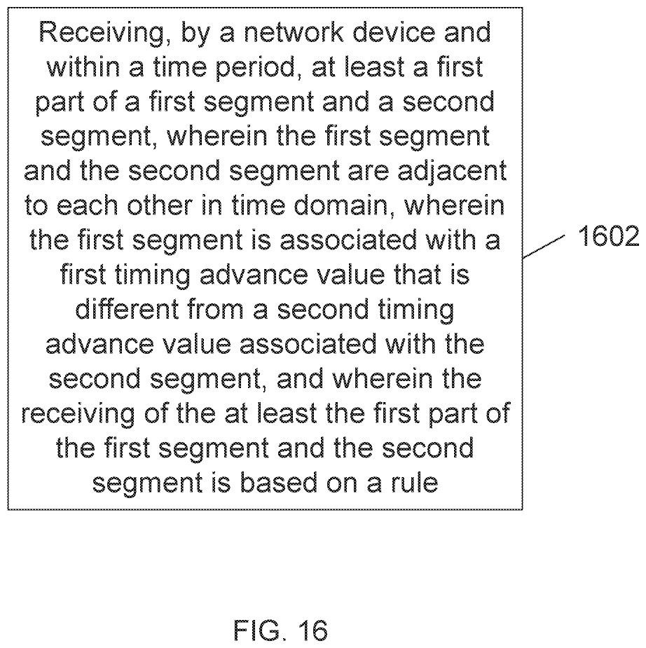

FIG. 16 shows an exemplary flowchart for reception of a segments. Operation 1602 includes receiving, by a network device and within a time period, at least a first part of a first segment and a second segment, wherein the first segment and the second segment are adjacent to each other in time domain, wherein the first segment is associated with a first timing advance value that is different from a second timing advance value associated with the second segment, and wherein the receiving of the at least the first part of the first segment and the second segment is based on a rule.

In some embodiments, the rule specifies that the first part of the first segment and the second segment are received in response to a second part of the first segment overlapping in time domain with the second segment, the second part of the first segment is located in time before the first part of the first segment, the first part of the first segment is located in time after the second segment, and the receiving within the time period excludes a reception of the second part of the first segment. In some embodiments, the rule specifies that the first part of the first segment and the second segment are received in response to a second part of the first segment overlapping in time domain with the second segment, the second part of the first segment is located in time after the first part of the first segment, the first part of the first segment is located in time before the second segment, and the receiving within the time period excludes a reception of the second part of the first segment.

In some embodiments, the first segment includes only the first part and a second part, the rule specifies that a time gap is located in between the first segment and the second segment, the second part of the first segment does not overlap with the second segment, and the receiving includes the first part of the first segment, the second part of the first segment, and the second segment. In some embodiments, the network device receives any one or more of: an elevation angle of a communication device, a velocity of the communication device, or a position of the communication device. In some embodiments, an apparatus for wireless communication comprising a processor, configured to implement a method recited for the techniques described in this patent document. In some embodiments, a non-transitory computer readable program storage medium having code stored thereon, the code, when executed by a processor, causing the processor to implement the techniques described in this patent document.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
transmitting, by a base station, a segmentation parameter for a physical channel via a system information block (SIB) or a radio resource control (RRC) signaling,
wherein the segmentation parameter includes a segment length.

2. The method of claim 1, wherein the physical channel includes a physical uplink shared channel (PUSCH).

3. The method of claim 1, wherein the physical channel includes a physical random access channel (PRACH).

4. A wireless communication method, comprising:
receiving, by a user equipment (UE), a segmentation parameter for a physical channel via a system information block (SIB) or a radio resource control (RRC) signaling,
wherein the segmentation parameter includes a segment length.

5. The method of claim 4, wherein the physical channel includes a physical uplink shared channel (PUSCH).

6. The method of claim 4, wherein the physical channel includes a physical random access channel (PRACH).

7. The method of claim 4, wherein an overlapping part of a second segment that overlaps with a first segment is dropped.

8. The method of claim 4, wherein an uplink gap is inserted between two adjacent segments.

9. The method of claim 4, wherein a narrowband internet of things physical uplink shared channel (NPUSCH) transmission that overlaps with a narrowband internet of things physical random access channel (NPRACH) occasion is postponed until a NPRACH transmission is finished in response to resources for the NPUSCH transmission overlapping with resources for the NPRACH occasion.

10. The method of claim 4, wherein a postponement or a dropping duration of a narrowband internet of things physical uplink shared channel (NPUSCH) due to a narrowband internet of things physical random access channel (NPRACH) collision is counted in segment duration.

11. An apparatus for wireless communication comprising a processor, configured to implement a method, the processor configured to:
transmit, by a base station, a segmentation parameter for a physical channel via a system information block (SIB) or a radio resource control (RRC) signaling,
wherein the segmentation parameter includes a segment length.

12. The apparatus of claim 11, wherein the physical channel includes a physical uplink shared channel (PUSCH).

13. The apparatus of claim 11, wherein the physical channel includes a physical random access channel (PRACH).

14. An apparatus for wireless communication comprising a processor, configured to implement a method, the processor configured to:
receive, by a user equipment (UE), a segmentation parameter for a physical channel via a system information block (SIB) or a radio resource control (RRC) signaling,
wherein the segmentation parameter includes a segment length.

15. The apparatus of claim 14, wherein the physical channel includes a physical uplink shared channel (PUSCH).

16. The apparatus of claim 14, wherein the physical channel includes a physical random access channel (PRACH).

17. The apparatus of claim 14, wherein an overlapping part of a second segment that overlaps with a first segment is dropped.

18. The apparatus of claim 14, wherein an uplink gap is inserted between two adjacent segments.

19. The apparatus of claim 14, wherein a narrowband internet of things physical uplink shared channel (NPUSCH) transmission that overlaps with a narrowband internet of things physical random access channel (NPRACH) occasion is postponed until a NPRACH transmission is finished in response to resources for the NPUSCH transmission overlapping with resources for the NPRACH occasion.

20. The apparatus of claim 14, wherein a postponement or a dropping duration of a narrowband internet of things physical uplink shared channel (NPUSCH) due to a narrowband internet of things physical random access channel (NPRACH) collision is counted in segment duration.
